(19) United States
(12) Patent Application Publication
(10) Pub. No.: US 2020/0229662 A1
(43) Pub. Date: Jul. 23, 2020

(54) TRAP FOR VACUUM CLEANER, AND RELATED SYSTEMS AND METHODS

(71) Applicants: Chris Lee, Renton, WA (US); Taylor Nuccitelli, Raleigh, NC (US)

(72) Inventors: Chris Lee, Renton, WA (US); Taylor Nuccitelli, Raleigh, NC (US)

(21) Appl. No.: 16/746,341

(22) Filed: Jan. 17, 2020

Related U.S. Application Data
(60) Provisional application No. 62/793,739, filed on Jan. 17, 2019.

(51) Int. Cl. A47L 9/10; A01M 3/00

(52) U.S. Cl. CPC A47L 9/10; A01M 3/005

(57) ABSTRACT

A device, for trapping an item in an intake hose of a vacuum before the item reaches a collection bin of the vacuum, includes a body and a screen. The body has a chamber, an entrance, and an exit. The chamber is configured such that when the chamber is coupled to an intake hose of a vacuum and the vacuum draws fluid into the intake hose, the fluid flows through the chamber. The entrance is couplable with an intake hose of a vacuum and configured such that when fluid flows through the body's chamber, the fluid enters the chamber through the entrance. The exit is coupleable with the intake hose of a vacuum and configured such that when fluid flows through the body's chamber, the fluid leaves the chamber through the exit. The screen of the device is disposed inside the body's chamber, and sized and configured to allow fluid that the vacuum draws in to flow through the body's chamber while preventing large objects suspended in the fluid from flowing through the body's chamber.

### BACKGROUND

Sometimes while using a vacuum, the vacuum draws in objects that one does not intend to be collected or taken. Examples of such objects include small animals and/or insects, and sharp objects. If a small animal and/or insect is drawn in, then it will be conveyed to the vacuum's collection bin, which is often a paper and/or cloth bag that functions as a filter, and could damage the collection bin trying to escape. If the animal and/or insect doesn't escape, then the animal and/or insect will perish. If a sharp object is drawn in, then it could damage the vacuum's intake hose as it is conveyed to the vacuum's collection bin, and could damage the collection bin when it reaches it.

Unfortunately, none of these possibilities is desirable because each could damage the vacuum's collection bin and or intake hose.

Thus, there is a need for a device that traps an item in an intake hose of a vacuum before the item reaches a collection bin of the vacuum.

### SUMMARY

In one aspect of the invention, a device for trapping an item in an intake hose of a vacuum before the item reaches a collection bin of the vacuum, includes a body and a screen. The body has a chamber that, when the chamber is coupled to an intake hose of a vacuum and the vacuum draws fluid into the intake hose, the fluid flows through the chamber. The body also has an entrance through which the fluid flows to enter the body's chamber, and an exit through which the fluid flows to leave the body's chamber, the exit being coupleable with the intake hose of a vacuum. The screen is disposed inside the body's chamber, and is sized and configured to allow fluid that the vacuum draws in to flow through the body's chamber while preventing large objects suspended in the fluid from flowing through the body's chamber.

With the device, an object, such as a spider, that one does not want to be trapped in a collection bin of a vacuum cleaner, is prevented from reaching the collection bin. This allows one to release the object from the vacuum cleaner without having to stop the vacuum and/or access the collection bin, and thus its contents. If the object is a living animal, such as a spider, then one can release the spider before it reaches the collection bin and perishes. If the object is an item that could damage the collection bin if it reached the collection bin, then one can prevent such damage by trapping and disposing of such an object before it reaches the collection bin.

In another aspect of the invention, a method for trapping an item in an intake hose of a vacuum before the item reaches a collection bin of the vacuum, includes: a) positioning a screen of a device in an intake hose of a vacuum, the device having a chamber, an entrance and an exit; b) urging fluid to flow into the intake hose, through the device, and toward a collection bin of the vacuum; and c) allowing the fluid to flow through the screen of the device while preventing a large object suspended in the flow of fluid from flowing through the device's exit.

### BRIEF DESCRIPTION OF THE DRAWINGS

FIG. 1 shows a view of a vacuum that includes a device coupled with an intake hose of the vacuum, for trapping an item before the item reaches a collection bin of the vacuum, according to an embodiment of the invention.

FIG. 2 shows a cross-sectional view of the device shown in FIG. 1 coupled to an intake hose of a vacuum, according to another embodiment of the invention.

FIG. 3 shows a perspective view of the device shown in FIGS. 1 and 2, according to an embodiment of the invention.

FIG. 4 shows a perspective, cross-sectional view of the device shown in FIG. 3, according to an embodiment of the invention.

### DETAILED DESCRIPTION

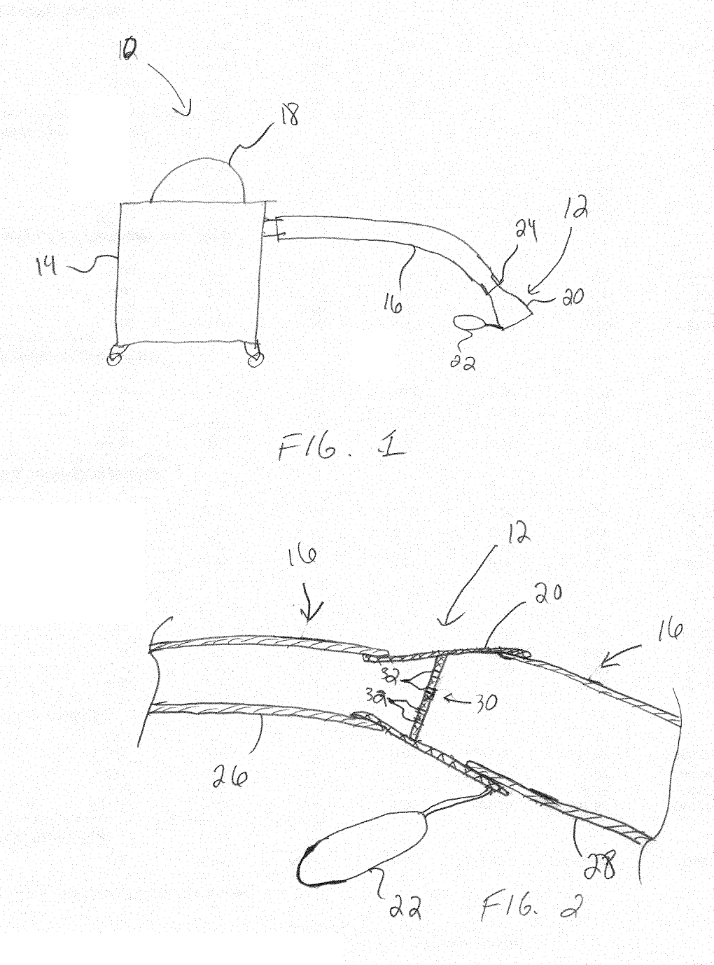

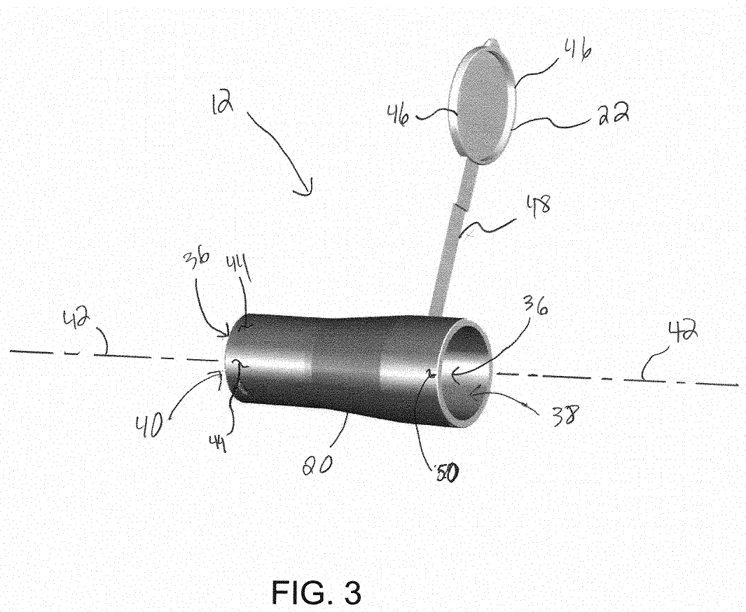

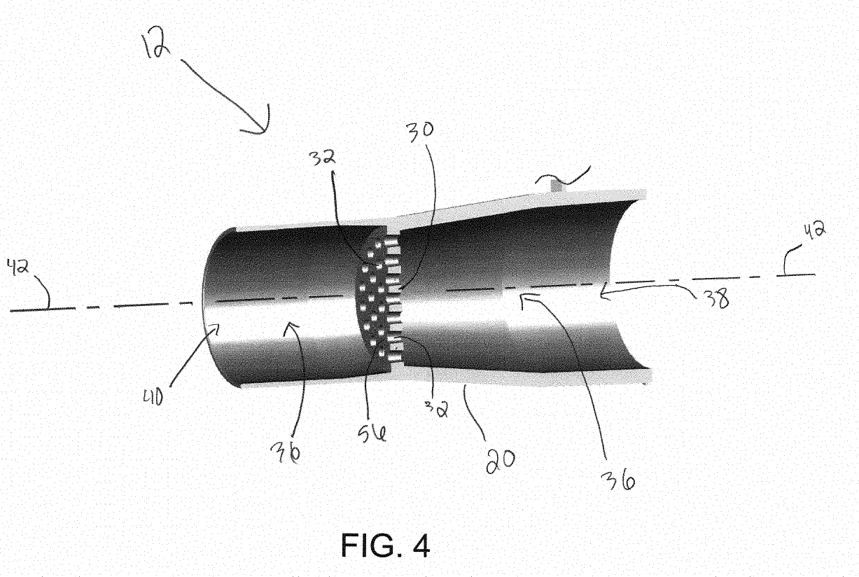

FIG. 1 shows a view of a vacuum 10 that includes a device 12 coupled to it, according to an embodiment of the invention. Here, the vacuum 10 traps and collects objects like dust and/or dirt by drawing in air that has the dust and/or dirt suspended in it. In other embodiments, the vacuum may draw in any other fluid such as water and/or gas, and traps and collects any other objects suspended in the drawn in fluid. The vacuum 10 includes a collection bin 14, an intake hose 16, and a blower 18 that draws air from the ambient environment into and through the intake hose 16, and into and through the collection bin 14, in which the objects suspended in the air drawn into the intake hose 16 are separated from the air and collected. The device 12 (discussed in greater detail in conjunction with FIGS. 3 and 4) is coupled to the intake hose 16 and includes a body 20, and a screen (not shown in FIG. 1, but shown in FIGS. 2-4) disposed inside the body. The screen is sized and configured to allow air to flow through the intake hose 16 while preventing large objects suspended in the air from entering the intake hose 16. In this and other embodiments, the device 12 also includes a cap 22 that one can use to close the device 12 and keep any object trapped in the device's body 20.

With the device 12, an object, such as a spider, that one does not want to be trapped in the collection bin 14 of the vacuum 10, is prevented from reaching the collection bin 14. This allows one to release the object from the vacuum 10 without having to stop the blower 18 of the vacuum 10 and/or access the collection bin 14, and thus its contents. If the object is a living animal, such as a spider, then one can release the spider before it reaches the collection bin 14 and perishes. If the object is an item that could damage the collection bin 14 if it reached the collection bin 14, then one can prevent such damage by trapping and disposing of such an object before it reaches the collection bin 14.

The device 12 may be coupled to the intake hose 16 in any desired manner. For example, in this and other embodiments the device 12 is releasably coupled to the front end or entrance 24 to the intake hose 16. More specifically, a portion of the body 20 slides inside the intake hose's entrance 24 and frictionally engages the inside surface of the intake hose's entrance 24. This friction, in combination with the flow of air through the device 12 and into the intake hose 16, holds the device 12 to the intake hose 16.

Other embodiments are possible. For example, the device 12 may be releasably coupled with the intake hose 16 by way of any other mechanism, such as Velcro, one or more threads, and/or one or more mechanical snaps. For another example, the device 12 may not be releasably coupled with the intake hose 16 and instead may be more permanently coupled with the intake hose 16 by way of an adhesive, one or more rivets, and/or corresponding flanges that are joined with bolts and corresponding nuts.

FIG. 2 shows a cross-sectional view of the device 12 shown in FIG. 1 coupled to an intake hose 16 of a vacuum (not shown), according to another embodiment of the invention. In this and other embodiments, the device 12 is coupled, releasably or more permanently as previously discussed, with two different portions of the intake hose 16, i.e. the device 12 is coupled to the intake hose 16 at a location other than the hose's front end or entrance 24. In such embodiments, the coupling of the device's body 20 may be accomplished using any of the techniques previously discussed above in conjunction with the device 12 being coupled to the entrance 24 of the hose 16. More specifically, the body 20 of the device 12 is coupled to a first portion 26 of the intake hose 16, and to a second portion 28 of the intake hose 16. Also shown in FIG. 2, the device 12 includes a screen 30 that has a plurality of holes 32 (only four shown) that allow fluid (here air) to flow from the intake hose's second portion 28 toward and into the intake hose's first portion 26, while preventing objects whose size is larger than the diameter of the holes from entering the intake hose's first portion 26.

Referring to FIGS. 1 and 2, the device 12 may be configured, as desired, to receive all of the air that the vacuum's blower 18 draws into the collection bin 14, or any portion of the air drawn in. In this and other embodiments the device 12 is configured to receive all of the air that the blower 18 draws in. In this manner, any object suspended in the air that the blower draws in and that should be kept out of the collection bin 14 and/or intake hose 16, is trapped by the device 12 before it reaches the collection bin 14 or enters the intake hose 16.

FIG. 3 shows a perspective view of the device 12 shown in FIGS. 1 and 2, according to an embodiment of the invention. As previously discussed, the device 12 includes a body 20, a screen 30 (shown in FIG. 4), and a cap 22. The body 20 includes a chamber 36 through which fluid flows when the device 12 is coupled to an intake hose 16 (FIGS. 1 and 2) and fluid is drawn into the hose 16. The body 20 also includes an entrance 38 through which fluid flows to enter the body's chamber 36, and an exit 40 through which fluid flows to leave the body's chamber 36.

The body 20, and its chamber, entrance and exit components 36, 38 and 40 respectively, may be sized and configured as desired. For example, in this and other embodiments each of the chamber, entrance and exit components are conical. This allows the device 12 to be easily coupled and uncoupled from a variety of intake hoses 16, each having a different diameter. More specifically, the chamber 36 has a longitudinal axis 42 and a circular cross-section at each point along the axis 42. The entrance 38 and the exit 40 are positioned in the chamber 36 such that the longitudinal axis 42 intersects the center of each. This reduces the loss in pressure in the fluid (here air) as it flows through the device 12 because the fluid does not have to change direction as it flows through the device 12, and thus reduces the power that the vacuum's blower 18 needs to provide to drawn the desired amount of fluid in through the intake hose 16 at a desired rate. When the device 12 is coupled to the intake hose 16 as shown in FIG. 1, the surface 44 of the body 20 that lies adjacent the exit 40, slides into the entrance 24 (FIG. 1) of the intake hose 16 and frictionally engages the inside surface of the entrance 24 to help secure the device 12 to the intake hose 16.

Still referring to FIG. 3, the cap 22 may be sized and configured as desired. For example, in this and other embodiments the cap 22 includes a skirt 46 and a leash 48 that couples the cap 22 with the device's body 20. The skirt 46 is sized and configured to slide over the surface 50 of the body 20 that lies adjacent the entrance 38 and frictionally engages the surface 50 to help secure the cap 22 over the entrance 38 when one wants to close the chamber 36 and retain objects trapped inside. The leash 48 is flexible to allow one to easily position the cap 22 anywhere relative to the body 20 and yet keep the cap 22 secured to the body. In other embodiments, the cap 22 may include a hinge that couples the cap 22 with the device's body 20.

Other embodiments are possible. For example, the device 12 may also include an ejector that urges objects trapped inside the body's chamber 36 out of the chamber 36. This may be desirable when the device frequently traps objects. Without such an ejector, one would have to frequently uncouple the device 12 from the intake hose 16 to eject the trapped objects. But with an ejector on can simply eject the objects without uncoupling and then re-coupling the device 12 with the intake hose 16. The ejector also allows one to empty the chamber 36 without having to touch the object. This may desirable when the object is an animal or insect such as a spider.

Still referring to FIG. 3, the body 20 and cap 22 may each be made of any desired material. For example, in this and other embodiments both the body 20 and the cap 22 are made of a conventional plastic. In other embodiments, the body 20, cap 22 or both may be made of a metal, such as aluminum.

FIG. 4 shows a perspective, cross-sectional view of the device 12 shown in FIG. 3, according to an embodiment of the invention. The screen 30 of the device 12 may be sized and configured as desired to trap any desired object. For example, in this and other embodiments the screen 30 includes a flat plate 56, and thirty-seven holes 32 (only 22 shown, two of which are labeled) each of which extends through the plate 56 and allows fluid (here air) to flow through the plate 56. In addition, the flat plate 56 extends across the narrowest portion of the chamber 36 and is oriented perpendicular to the flow of fluid through chamber 36. More specifically, the screen is a circular disk having a diameter of about 1.5 inches and each of the thirty-seven holes 32 has a diameter of 0.125 inches. These dimensions provide a ratio of the total area of the screen to the total area of the holes 32 through the screen, of about 3.8. Depending on the size of the objects to be trapped by the device 12 and the amount of fluid and the rate at which it flows through the device 12, this ratio may be increased or decreased by changing either the size of one or more of the holes 32 and/or the total number of holes 32 in the screen 30.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A device for trapping an item in an intake hose of a vacuum before the item reaches a collection bin of the vacuum, the device comprising:
a body having:
a chamber that, when the chamber is coupled to an intake hose of a vacuum and the vacuum draws fluid into the intake hose, the fluid flows through the chamber,
an entrance through which the fluid flows to enter the body's chamber, and
an exit through which the fluid flows to leave the body's chamber, the exit being coupleable with the intake hose of a vacuum; and
a screen disposed inside the body's chamber, the screen sized and configured to allow fluid that the vacuum draws in to flow through the body's chamber while preventing large objects suspended in the fluid from flowing through the body's chamber.

2. The device of claim 1 wherein each of the body's exit is releasably coupled to the intake hose.

3. The device of claim 1 wherein the body's entrance is also coupleable with the intake hose of a vacuum.

4. The device of claim 1 wherein the body's entrance is releasably coupleable with the intake hose of a vacuum.

5. The device of claim 1 wherein the body is configured to receive all of the fluid that the vacuum draws in, when the device is coupled to an intake hose of the vacuum and the vacuum draws in fluid.

6. The device of claim 1 wherein the body's chamber includes a circular cross-section.

7. The device of claim 1 wherein the body's chamber, entrance and exit are conical in shape, and the body's chamber includes a longitudinal axis that intersects the center of the body's entrance and the center of the body's exit.

8. The device of claim 1 wherein the body's entrance is sized and configured to cover a portion of an intake hose of a vacuum and frictionally engage the portion, when the body's entrance is coupled to the intake hose.

9. The device of claim 1 wherein the body's exit is sized and configured to be covered by a portion of an intake hose of a vacuum and frictionally engage the portion, when the body's exit is coupled to the intake hose.

10. The device of claim 1 wherein:
the body's chamber is conical in shape, and
the screen extends across the narrowest portion of the body's chamber.

11. The device of claim 1 wherein the screen is disposed in the chamber such that the screen lies perpendicular to the flow of fluid through the chamber, when fluid flows through the chamber.

12. The device of claim 1 wherein the screen includes a hole through which fluid can flow to reach the body's exit, the hole being cylindrical in shape.

13. The device of claim 1 wherein the screen:
is cylindrical in shape,
includes thirty-seven holes that are evenly distributed throughout the screen and through each of which fluid can flow to reach the body's exit, and
has a ratio of 3.8 that is defined by the total area of the screen divided by the total area of the holes through the screen.

14. The device of claim 1 wherein large objects include spiders.

15. The device of claim 1 further comprising a cap sized and configured to cover the body's entrance, and operable to prevent a large object inside the body's chamber from leaving the body's chamber, when fluid no longer flows through the body's chamber.

16. A method for trapping an item in an intake hose of a vacuum before the item reaches a collection bin of the vacuum, the method comprising:
positioning a screen of a device in an intake hose of a vacuum, the device having a chamber, an entrance and an exit;
urging fluid to flow into the intake hose, through the device, and toward a collection bin of the vacuum; and
allowing the fluid to flow through the screen of the device while preventing a large object suspended in the flow of fluid from flowing through the device's exit.

17. The method of claim 16 wherein positioning the screen in an intake hose includes releasably coupling the device's exit to a portion of the intake hose.

18. The method of claim 17 wherein releasably coupling the device's entrance to a portion of the intake hose includes the device's exit frictionally engaging a portion of the intake hose.

19. The method of claim 16 wherein positioning a screen of the device in an intake hose includes positioning the screen between two portions of the intake hose.

20. The method of claim 19 wherein positioning a screen between two portions of the intake hose includes releasably coupling the device's entrance to a portion of the intake hose and releasably coupling the device's exit to another portion of the intake hose.

21. The method of claim 16 wherein urging fluid to flow into the intake hose includes urging air to flow into the intake hose.

22. The method of claim 16 wherein preventing a large object suspended in the flow of fluid from flowing the device's exit includes blocking the object with the screen.

23. A vacuum comprising:
an intake hose for drawing in a fluid;
a collection bin coupled to an end of the intake hose; and
a device for trapping an object suspended in the fluid flowing in the intake hose before the object reaches the collection bin, the device comprising:
a body having:
a chamber through which flows fluid that is drawn into the intake hose,
an entrance through which the fluid flows to enter the body's chamber, and
an exit coupled with the intake hose, and through which the fluid flows to leave the body's chamber; and
a screen disposed inside the body's chamber, the screen sized and configured to allow fluid drawn into the intake hose to flow through the body's chamber while preventing large objects suspended in the fluid from flowing through the body's chamber.

24. The vacuum of claim 23 wherein the fluid that the vacuum draws in is air.

25. The vacuum of claim 23 wherein the device's exit is releasably coupled to a portion of the intake hose.

26. The vacuum of claim 23 wherein the device traps a spider and prevents it from entering the collection bin, when the spider is suspended in the fluid drawn into the intake hose.
